(19) United States
(12) Patent Application Publication
(10) Pub. No.: US 2026/0020572 A1
(43) Pub. Date: Jan. 22, 2026

(54) Use of Biomass-Derived Nano-Biochar as a Crop-Growth-Promoting Foliar Spraying Fertilizer in Crop Planting, and Foliar Spraying Method

(71) Applicant: Institute of Soil Science, Chinese Academy of Sciences, Nanjing (CN)

(72) Inventors: Yujun WANG, Nanjing (CN); Xiangdong ZHU, Nanjing (CN); Ruijuan SUN, Nanjing (CN); Song WU, Nanjing (CN)

(21) Appl. No.: 18/961,090

(22) Filed: Nov. 26, 2024

(30) Foreign Application Priority Data
Jul. 18, 2024 (CN) 202410962638.7

(51) Int. Cl. A01N 61/00; A01N 25/02; C10B 53/02

(52) U.S. Cl. CPC A01N 61/00; A01N 25/02; C10B 53/02

(57) ABSTRACT

Use of a biomass-derived nano-biochar crop-growth-promoting material as a foliar spraying fertilizer in crop planting, and a foliar spraying method are provided, which belong to the technical field of nano-enabled agriculture. In this application, biomass-derived nano-biochar with a thin-sheet layer structure is inserted into a cell wall of a leaf surface of a crop, and meanwhile the biomass-derived nano-biochar with a high degree of graphitization of a turbostratic structure can efficiently export excess electrons in the crop to allow the weakening of reactive oxygen species, thereby allowing the purpose of growth promotion and yield increase for the crop. This application applies a biomass-derived nano-biochar crop-growth-promoting material as a foliar spraying fertilizer to a crop to promote the growth of the crop for the first time.

### CROSS REFERENCE TO RELATED APPLICATION

This patent application claims the benefit and priority of Chinese Patent Application No. 202410192638.7 filed with the China National Intellectual Property Administration on Jul. 18, 2024, the disclosure of which is incorporated by reference herein in its entirety as part of the present application.

### TECHNICAL FIELD

The present disclosure relates to the technical field of nano-enabled agriculture, and in particular to a use of a biomass-derived nano-biochar as a crop-growth-promoting foliar spraying fertilizer in crop planting, and a foliar spraying method.

### BACKGROUND

The nano-enabled agriculture is an emerging field of applying nanotechnologies to agriculture. The nano-enabled agriculture aims to improve the crop production efficiency, reduce the utilization of resource and influence on environmental, and improve the agricultural product quality. Nanomaterials have been widely used in seed treatment, fertilizer application, plant protection, soil improvement, or the like. For example, nanomaterials can be used as carriers to provide nutrients, plant hormones, or pesticides and to improve the soil structure and water management, thereby promoting the yield increase for crops. Although the application of nanomaterials in agriculture brings a lot of potential benefits, a large number of nanomaterials currently in use include metallic elements, and the long-term use of these nanomaterials can lead to metal accumulation, which leads to environmental pollution. In addition, some nanotechnologies have a high cost in practical applications, which limits the promotion and application of these nanotechnologies in agricultural production.

The Chinese patent CN106747954A discloses a graphene nanomaterial-containing foliar fertilizer. The graphene nanomaterial-containing foliar fertilizer can be applied at a dosage at least 0.08 g/pot by root application method, and there is a problem of high dosage.

### SUMMARY

In view of this, an objective of the present disclosure is to provide a use of a biomass-derived nano-biochar crop-growth-promoting material as a foliar spraying fertilizer in crop planting, and a foliar spraying method. When the biomass-derived nano-biochar crop-growth-promoting material of the present disclosure is sprayed on leaf surfaces of a crop to promote the growth of the crop, the dosage of the biomass-derived nano-biochar crop-growth-promoting material can be greatly reduced.

To allow the objective of the present disclosure, the present disclosure provides the following technical solutions:

The present disclosure provides a use of a biomass-derived nano-biochar crop-growth-promoting material as a foliar spraying fertilizer in crop planting.

Preferably, the use includes: spraying the biomass-derived nano-biochar crop-growth-promoting material on leaf surfaces of a crop.

The present disclosure also provides a foliar spraying method, including the following steps:
dispersing a biomass-derived nano-biochar crop-growth-promoting material in water to obtain a biomass-derived nano-biochar solution; and
spraying the biomass-derived nano-biochar solution on leaf surfaces of a crop.

Preferably, the dosage of the biomass-derived nano-biochar crop-growth-promoting material in biomass-derived nano-biochar solution is sprayed at 1 g/ha to 18 g/ha.

Preferably, the biomass-derived nano-biochar crop-growth-promoting material is sprayed at 5 g/ha to 10 g/ha.

Preferably, a concentration of the biomass-derived nano-biochar solution is more than 0 mg/L and no more than 50 mg/L.

Preferably, a concentration of the biomass-derived nano-biochar solution is 10 mg/L to 20 mg/L.

Preferably, the dispersing refers to dispersion by ultrasonic.

Preferably, the biomass-derived nano-biochar crop-growth-promoting material is prepared through the following steps:
crushing a biomass to obtain a biomass powder;
subjecting the biomass powder to pyrolytic carbonization under an anaerobic condition and then cooling to obtain biochar; and
subjecting the biochar to current self-heating carbonization and then cooling to obtain the biomass-derived nano-biochar crop-growth-promoting material.

Preferably, the pyrolytic carbonization is conducted at a temperature of 500° C. to 1,500° C. for 1 h to 8 h; and the current self-heating carbonization is conducted at a voltage of 100 V to 380 V for more than 0 s and no more than 60 s.

The present disclosure provides a use of a biomass-derived nano-biochar crop-growth-promoting material as a foliar spraying fertilizer in crop planting.

Compared with the prior art, the present disclosure has the following beneficial effects:
The biomass-derived nano-biochar has a graphite thin-sheet layer structure with a high degree of graphitization of a turbostratic structure, and has the ability to transfer electrons quickly. Too many reactive oxygen radicals will be produced in a crop during a growth process, which is not conducive to the growth of the crop and may cause a reduced yield. The biomass-derived nano-biochar has the ability to quickly export electrons. In the present disclosure, the biomass-derived nano-biochar with a thin-sheet layer structure is inserted into a cell wall of a leaf surface of a crop, meanwhile the biomass-derived nano-biochar with a high degree of graphitization of a turbostratic structure can efficiently export excess electrons in the crop to allow the weakening of reactive oxygen species, thereby allowing the purpose of growth promotion and yield increase for the crop. The present disclosure applies a biomass-derived nano-biochar crop-growth-promoting material to crop foliar sparying to promote the growth of the crop for the first time. The biomass-derived nano-biochar crop-growth-promoting material can be applied at a small dosage to allow a high yield, which overcomes the problem that the traditional root application method requires a high fertilizer dosage. The present disclosure can allow the purpose of fully increasing a yield with a low fertilizer dosage (18 g/ha). The method of the present disclosure is expected to become a safe, low-cost, efficient, and eco-friendly new-generation method for promoting the growth of crops, and can be widely used in the growth promotion and yield increase of crops. Therefore, the present disclosure provides a new way to solve the current food safety problems for crops.

Moreover, the biomass-derived nano-biochar crop-growth-promoting material of the present disclosure does not cause problems such as secondary environmental pollution, resource shortage, and high cost, and is of great significance for environmental protection and food safety. Further, in the present disclosure, biomass-derived nano-biochar is synthesized through a pyrolytic carbonization/current self-heating carbonization coupled technology. During the above synthesis process, non-carbon elements in a biomass undergo volatilization and carbonization, and carbon atoms are then graphitized through high-temperature rearrangement to produce the biomass-derived nano-biochar with a higher degree of graphitization, which can further improve a yield of a crop and has considerable ecological, environmental, and economic benefits.

### BRIEF DESCRIPTION OF THE DRAWINGS

FIG. 1 shows transmission electron microscopy (TEM) images of biocarbon and a bamboo powder biomass-derived nano-biochar material at different magnifications;

FIG. 2 shows growth-promoting and yield-increasing effects of bamboo powder biomass-derived nano-biochar sprayed at different concentrations for Zea mays;

FIG. 3 shows growth-promoting and yield-increasing effects of bamboo powder biomass-derived nano-biochar sprayed at different concentrations for Glycine max;

FIG. 4 shows growth-promoting and yield-increasing effects of bamboo powder biomass-derived nano-biochar sprayed at different concentrations for Arachis hypogaea;

FIG. 5 shows growth-promoting and yield-increasing effects of bamboo powder biomass-derived nano-biochar for different crops in a field experiment;

FIG. 6 shows physical pictures of the growth promotion and yield increase of nano-carbon prepared from different raw materials for Arabidopsis thaliana;

FIG. 7 shows growth-promoting and yield-increasing effects of nano-carbon prepared from different raw materials for Arabidopsis thaliana;

FIG. 8 shows impacts of bamboo powder biocarbon and nano-carbon on the generation of free radicals in Arabidopsis thaliana based on fluorescence;

FIG. 9 shows impacts of bamboo powder biomass-derived nano-biochar sprayed at different concentrations on the generation of free radicals in Arabidopsis thaliana based on fluorescence;

FIG. 10 is a physical picture of the growth promotion and yield increase of the bamboo powder nano-carbon prepared in Example 1 sprayed at 10 mg/L for Glycine max in a field experiment;

FIG. 11 is a physical picture of the growth promotion and yield increase of the bamboo powder nano-carbon prepared in Example 1 sprayed at 10 mg/L for Arachis hypogaea in a field experiment; and

FIG. 12 is a physical picture of the growth promotion and yield increase of the bamboo powder nano-carbon prepared in Example 1 sprayed at 10 mg/L for Zea mays in a field experiment.

### DETAILED DESCRIPTION OF THE EMBODIMENTS

The present disclosure provides a use of a biomass-derived nano-biochar crop-growth-promoting material as a foliar spraying fertilizer in crop planting.

In the present disclosure, the biomass-derived nano-biochar crop-growth-promoting material refers to a biomass-derived nano-biochar material.

In the present disclosure, the use preferably includes: the biomass-derived nano-biochar crop-growth-promoting material is sprayed on leaf surfaces of a crop.

In the present disclosure, the biomass-derived nano-biochar has a graphite thin-sheet layer structure with a turbostratic structure, which is conducive to electron transport. When the biomass-derived nano-biochar is sprayed on leaf surfaces of a crop, the biomass-derived nano-biochar with a thin sheet layer structure can be inserted into a cell wall of a leaf surface of a crop, meanwhile biomass-derived nano-biochar with a high degree of graphitization of a turbostratic structure can efficiently export excess electrons in the crop to allow the weakening of reactive oxygen species, thereby allowing the purpose of growth promotion and yield increase for the crop. Compared with the traditional agricultural growth-promotion mode (root application), the foliar spraying of the present disclosure can allow the purpose of fully increasing a yield with a low fertilizer dosage (18 g/ha).

In the present disclosure, the biomass-derived nano-biochar crop-growth-promoting material is preferably prepared through the following steps:

A biomass is crushed to obtain a biomass powder.

The biomass powder is subjected to pyrolytic carbonization under an anaerobic condition and then cooled to obtain biocarbon.

The biocarbon is subjected to current self-heating carbonization and then cooled to obtain the biomass-derived nano-biochar crop-growth-promoting material.

In the present disclosure, a biomass is crushed to obtain a biomass powder.

In the present disclosure, the biomass preferably includes one or more selected from the group consisting of a wood chip, a crop straw, a rice husk, a corn cob, a sugarcane bagasse, a soybean dreg, a rape seed cake, a microalgae, a walnut shell, Salix psammophila, a bamboo, a leaf and bark, and a plastic.

The present disclosure has no special definition on the crushing, and a crushing manner well known to those skilled in the art can be adopted.

In the present disclosure, after the biomass powder is obtained, the biomass powder is subjected to pyrolytic carbonization under an anaerobic condition and then cooled to obtain biocarbon.

In the present disclosure, the pyrolytic carbonization is conducted at a temperature of preferably 500° C. to 1,500° C. and more preferably 700° C. to 1,000° C. for preferably 1 h to 8 h and more preferably 1.5 h to 3 h.

In the present disclosure, a heating rate from room temperature to the temperature for the pyrolytic carbonization is preferably 5° C./min.

In the present disclosure, the anaerobic condition is preferably provided by nitrogen at a flow rate of preferably 100 mL/min.

In the present disclosure, the cooling is preferably natural cooling to room temperature.

In the present disclosure, after the biocarbon is obtained, the biocarbon is subjected to current self-heating carbonization and then cooled to obtain the biomass-derived nano-biochar crop-growth-promoting material.

In the present disclosure, the current self-heating carbonization is conducted at a voltage of preferably 100 V to 380 V for preferably more than 0 s and no more than 60 s.

In the present disclosure, preferably, the biocarbon is placed in a quartz tube, a carbon rod and a copper wire ball are placed at two ends of the quartz tube, respectively, and then the quartz tube is placed in a current self-heating device to allow the current self-heating carbonization. During the current self-heating carbonization, there is preferably no need to add a conductive additive.

After the current self-heating carbonization, natural cooling is preferably conducted to room temperature to obtain the biomass-derived nano-biochar crop growth-promoting material.

In the present disclosure, biomass-derived nano-biochar is synthesized through a pyrolytic carbonization/current self-heating carbonization coupled technology. During the above synthesis process, non-carbon elements in a biomass undergo volatilization and carbonization, and carbon atoms are then graphitized through high-temperature rearrangement to produce the biomass-derived nano-biochar with a high degree of graphitization.

The present disclosure also provides a foliar spraying method, including the following steps:

A biomass-derived nano-biochar crop-growth-promoting material is dispersed in water to obtain a biomass-derived nano-biochar solution.

The biomass-derived nano-biochar solution is sprayed on leaf surfaces of a crop.

In the present disclosure, a biomass-derived nano-biochar crop-growth-promoting material is dispersed in water to obtain a biomass-derived nano-biochar solution.

In the present disclosure, a concentration of the biomass-derived nano-biochar solution is preferably more than 0 mg/L and no more than 50 mg/L, and is more preferably 10 mg/L to 20 mg/L.

In the present disclosure, the dispersing preferably is conducted by ultrasonic. The present disclosure has no special definition on parameters of the ultrasonic as long as the uniform dispersion can be guaranteed.

In the present disclosure, after the biomass-derived nano-biochar solution is obtained, the biomass-derived nano-biochar solution is sprayed on leaf surfaces of a crop.

In the present disclosure, the dosage of the biomass-derived nano-biochar crop-growth-promoting material in the biomass-derived nano-biochar solution is sprayed at preferably 1 g/ha to 18 g/ha and more preferably 5 g/ha to 10 g/ha, where the ha refers to an area of land.

In the present disclosure, the spraying is preferably conducted multiple times, and a spraying volume and a spraying time are preferably determined according to different crop growth stages and demands. The spraying method is preferably determined according to a crop region, as long as the even spraying can be allowed.

The technical solutions of the present disclosure will be clearly and completely described below with reference to the examples of the present disclosure. Apparently, the described examples are merely some rather than all of the examples of the present disclosure. All other examples obtained by those of ordinary skill in the art based on the examples of the present disclosure without creative efforts shall fall within the protection scope of the present disclosure.

### Example 1

A bamboo powder biomass was crushed into a powder, and then pyrolyzed at 700° C. for 90 min under an anaerobic condition with a heating rate of 5° C./min and a nitrogen flow rate of 100 mL/min to obtain a biocarbon. The biocarbon was weighed and placed in a quartz tube, and a carbon rod and a copper wire ball were placed at two ends of the quartz tube, respectively. Then the quartz tube was placed in a current self-heating device. The current self-heating carbonization was conducted at a voltage of 200 V for 50 ms with 2 times of pulsing to obtain a product, and the product was cooled to room temperature to obtain bamboo powder biomass-derived nano-biochar (bamboo powder nano-carbon).

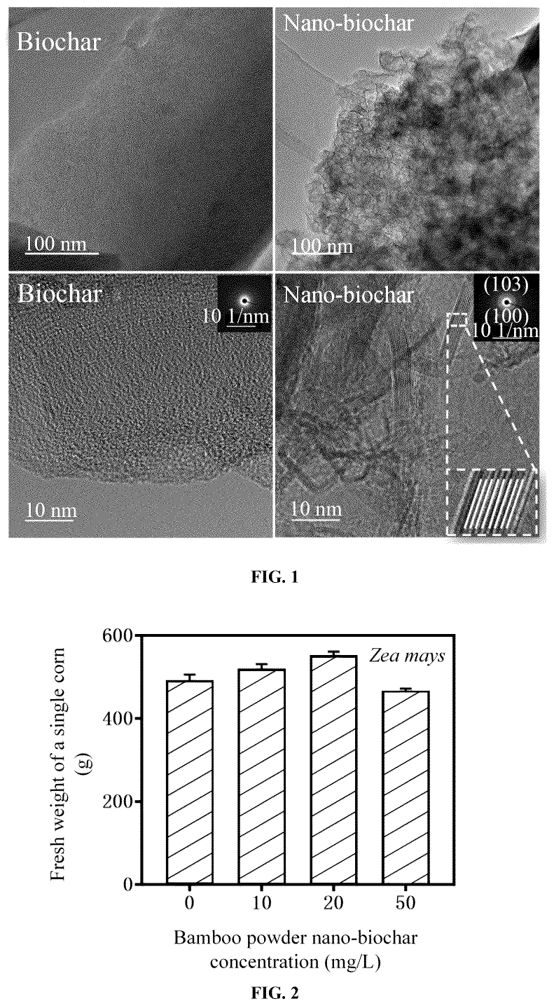

The biocarbon and the bamboo powder biomass-derived nano-biochar each were subjected to transmission electron microscopy analysis, and analysis results were shown in FIG. 1. It can be seen from FIG. 1 that the biocarbon has a low degree of graphitization and does not have a diffraction peak during selected-area diffraction, and after being treated by the current self-heating technology, the obtained bamboo powder biomass-derived nano-biochar has an obvious graphite sheet layer structure and diffraction peak, indicating that the bamboo powder biomass-derived nano-biochar has been successfully synthesized.

The bamboo powder biomass-derived nano-biochar was weighed, added with ultrapure water, and ultrasonically dispersed to prepare bamboo powder biomass-derived nano-biochar solutions with concentrations of 10 mg/L, 20 mg/L, and 50 mg/L, respectively.

The bamboo powder biomass-derived nano-biochar solutions each were sprayed on leaf surfaces of the crop Zea mays to determine a growth-promoting and yield-increasing effect of the bamboo powder biomass-derived nano-biochar for the crop Zea mays, and results were shown in FIG. 2. FIG. 2 shows that the bamboo powder biomass-derived nano-biochar has an obvious growth-promoting and yield-increasing effect for Zea mays at both 10 mg/L and 20 mg/L.

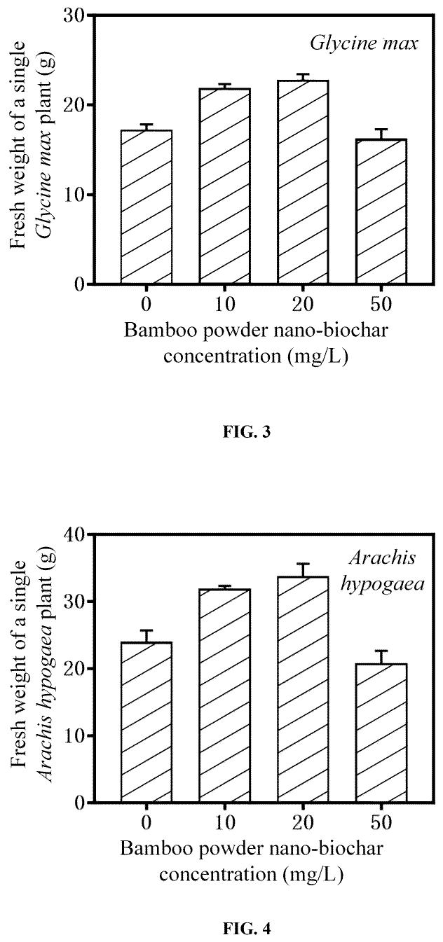

The bamboo powder biomass-derived nano-biochar solutions each were sprayed on leaf surfaces of Glycine max to determine a growth-promoting and yield-increasing effect of the bamboo powder biomass-derived nano-biochar for Glycine max, and results were shown in FIG. 3. FIG. 3 shows that the bamboo powder biomass-derived nano-biochar has an obvious growth-promoting and yield-increasing effect for Glycine max at both 10 mg/L and 20 mg/L.

The bamboo powder biomass-derived nano-biochar solutions each were sprayed on leaf surfaces of Arachis hypogaea to determine a growth-promoting and yield-increasing effect of the bamboo powder biomass-derived nano-biochar for Arachis hypogaea, and results were shown in FIG. 4. FIG. 4 shows that the bamboo powder biomass-derived nano-biochar has an obvious growth-promoting and yield-increasing effect for Arachis hypogaea at both 10 mg/L and 20 mg/L.

### Example 2

This example was different from Example 1 merely in that the pulsing was conducted once at a voltage of 250 V for 6 s and then once at a voltage of 200 V for 30 ms to obtain bamboo powder biomass-derived nano-biochar.

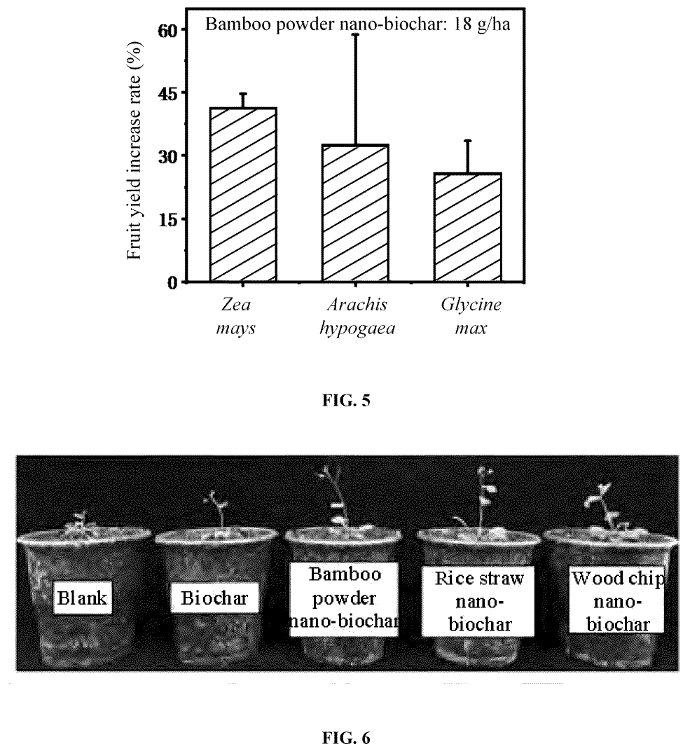

A corresponding bamboo powder biomass-derived nano-biochar solution was sprayed on leaf surfaces of Zea mays, Arachis hypogaea, and Glycine max with of the biomass-derived nano-biochar in the bamboo powder biomass-derived nano-biochar solution at a dosage of 18 g/ha (the ha here referred to an area of land) to determine a growth-promoting and yield-increasing effect, and results were shown in FIG. 5. FIG. 5 shows that, the bamboo powder biomass-derived nano-biochar has a significant growth-promoting and yield-increasing effect for the above crops at an dosage of 18 g/ha.

### Example 3

This example was different from Example 1 merely in that the bamboo powder was replaced with a rice straw to prepare rice straw biomass-derived nano-biochar (rice straw carbon).

### Example 4

This example was different from Example 1 merely in that the bamboo powder was replaced with a wood chip to prepare wood chip biomass-derived nano-biochar (wood chip carbon).

The different biomass-derived nano-biochar samples in Examples 1, 3, and 4 each were weighed, added with ultrapure water, and ultrasonically dispersed to prepare different biomass-derived nano-biochar solutions each with a concentration of 10 mg/L.

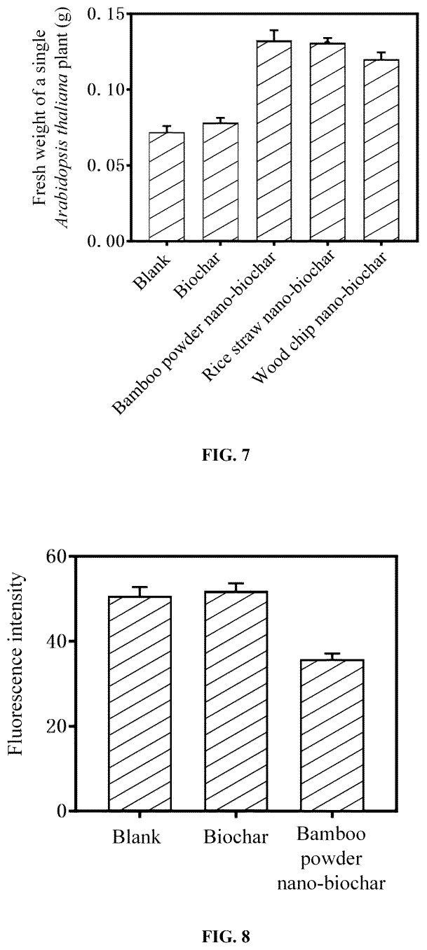

The biocarbon prepared in Example 1 (which was prepared into a solution with a concentration of 10 mg/L) and the different biomass-derived nano-biochar solutions each were sprayed on leaf surfaces of Arabidopsis thaliana to determine growth-promoting and yield-increasing effects of the biocarbon and the different biomass-derived nano-biochar samples for Arabidopsis thaliana. FIG. 6 shows physical pictures of the growth promotion and yield increase of the nano-carbon prepared from different raw materials for Arabidopsis thaliana. FIG. 7 shows growth-promoting and yield-increasing effects of the nano-carbon prepared from different raw materials for Arabidopsis thaliana. FIG. 7 shows that the different biomass-derived nano-biochar samples all have an obvious growth-promoting and yield-increasing effect for Arabidopsis thaliana, which were better than that of the biocarbon.

The biocarbon and the bamboo powder biomass-derived nano-biochar prepared in Example 1 each were weighed, added with ultrapure water, and ultrasonically dispersed to prepare a biocarbon solution and a bamboo powder biomass-derived nano-biochar solution each with a concentration of 10 mg/L. The biocarbon solution and the bamboo powder biomass-derived nano-biochar solution each were sprayed on leaf surfaces of Arabidopsis thaliana, and then a fluorescence intensity of Arabidopsis thaliana was determined through fluorescence labeling. Results were shown in FIG. 8. FIG. 8 shows that, compared with the blank and the biocarbon, the bamboo powder biomass-derived nano-biochar can greatly reduce the generation of hydroxyl radicals in Arabidopsis thaliana at 10 mg/L, which further proves that the bamboo powder nano-carbon can export electrons to reduce the generation of free radicals.

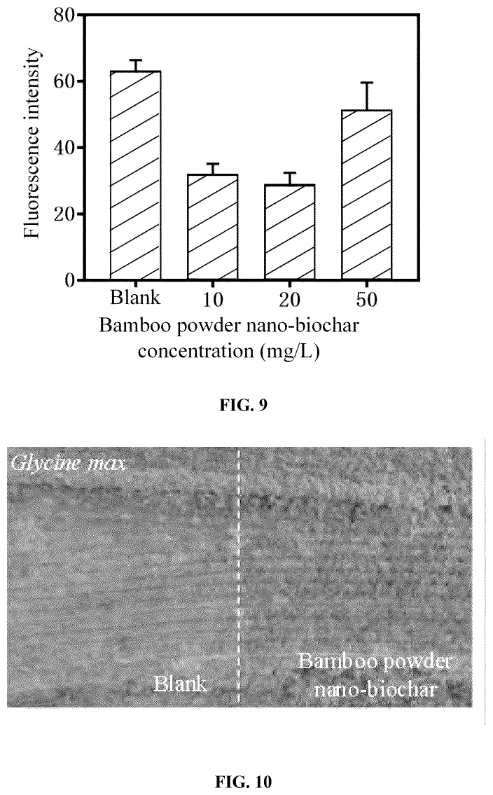

The bamboo powder biomass-derived nano-biochar prepared in Example 1 was weighed, added with ultrapure water, and ultrasonically dispersed to prepare bamboo powder biomass-derived nano-biochar solutions with concentrations of 10 mg/L, 20 mg/L, and 50 mg/L, respectively. The bamboo powder biomass-derived nano-biochar solutions each were sprayed on leaf surfaces of Arabidopsis thaliana, and then a fluorescence intensity of Arabidopsis thaliana was determined through fluorescence labeling. Results were shown in FIG. 9. FIG. 9 shows that, compared with the blank and the bamboo powder biomass-derived nano-biochar at 50 mg/L, the bamboo powder biomass-derived nano-biochar at both 10 mg/L and 20 mg/L can greatly reduce the generation of hydroxyl radicals in Arabidopsis thaliana, which further proves that the bamboo powder nano-carbon can export electrons to reduce the generation of free radicals and promote the yield increase.

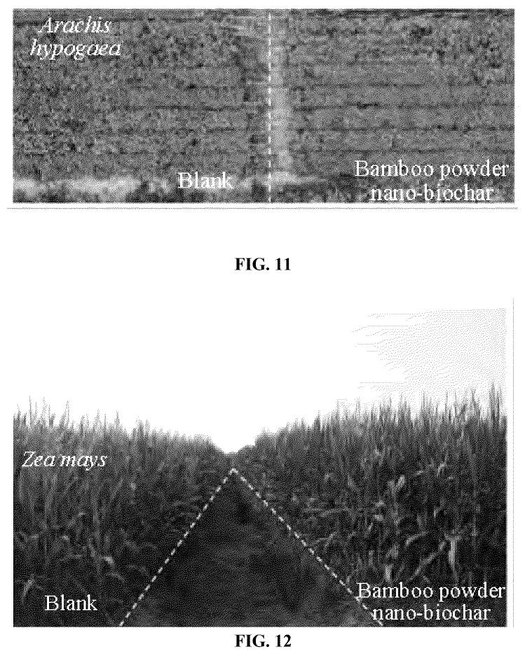

FIG. 10 is a physical picture of the growth promotion and yield increase of the bamboo powder nano-carbon prepared in Example 1 sprayed at 10 mg/L for Glycine max in a field experiment. FIG. 11 is a physical picture of the growth promotion and yield increase of the bamboo powder nano-carbon prepared in Example 1 sprayed at 10 mg/L for Arachis hypogaea in a field experiment. FIG. 12 is a physical picture of the growth promotion and yield increase of the bamboo powder nano-carbon prepared in Example 1 sprayed at 10 mg/L for Zea mays in a field experiment. It can be seen that the biomass-derived nano-biochar can promote the yield increase of a crop when used as a foliar spraying fertilizer.

The above are merely preferred embodiments of the present disclosure rather than limitations to the present disclosure in any form. It should be noted that those of ordinary skill in the art may further make several improvements and modifications without departing from the principle of the present disclosure, but such improvements and modifications should be deemed as falling within the protection scope of the present disclosure.

What is claimed is:

1. A method for preparing a foliar spraying fertilizer in crop planting, comprising using a biomass-derived nano-biochar crop-growth-promoting material.

2. The method according to claim 1, comprising: spraying the biomass-derived nano-biochar crop-growth-promoting material on leaf surfaces of a crop.

3. A foliar spraying method, comprising the following steps:
dispersing a biomass-derived nano-biochar crop-growth-promoting material in water to obtain a biomass-derived nano-biochar solution; and
spraying the biomass-derived nano-biochar solution on leaf surfaces of a crop.

4. The foliar spraying method according to claim 3, wherein the biomass-derived nano-biochar crop-growth-promoting material in the biomass-derived nano-biochar solution is sprayed at a dosage of 1 g/ha to 18 g/ha.

5. The foliar spraying method according to claim 4, wherein the biomass-derived nano-biochar crop-growth-promoting material in the biomass-derived nano-biochar solution is sprayed at a dosage of 5 g/ha to 10 g/ha.

6. The foliar spraying method according to claim 3, wherein a concentration of the biomass-derived nano-biochar solution is more than 0 mg/L and no more than 50 mg/L.

7. The foliar spraying method according to claim 6, wherein a concentration of the biomass-derived nano-biochar solution is 10 mg/L to 20 mg/L.

8. The foliar spraying method according to claim 3, wherein the dispersing refers to dispersion by ultrasonic.

9. The foliar spraying method according to claim 3, wherein the biomass-derived nano-biochar crop-growth-promoting material is prepared through the following steps:
crushing a biomass to obtain a biomass powder;
subjecting the biomass powder to pyrolytic carbonization under an anaerobic condition and then cooling to obtain biocarbon; and
subjecting the biocarbon to current self-heating carbonization and then cooling to obtain the biomass-derived nano-biochar crop-growth-promoting material.

10. The foliar spraying method according to claim 9, wherein the pyrolytic carbonization is conducted at a temperature of 500° C. to 1,500° C. for 1 h to 8 h; and the current self-heating carbonization is conducted at a voltage of 100 V to 380 V for more than 0 s and no more than 60 s.

11. The foliar spraying method according to claim 6, wherein the biomass-derived nano-biochar crop-growth-promoting material in the biomass-derived nano-biochar solution is sprayed at a dosage of 1 g/ha to 18 g/ha.
